(19) United States
(12) Patent Application Publication
(10) Pub. No.: US 2011/0138395 A1
(43) Pub. Date: Jun. 9, 2011

(54) THERMAL MANAGEMENT IN MULTI-CORE PROCESSOR

(75) Inventor: Andrew WOLFE, Los Gatos, CA (US)

(73) Assignee: EMPIRE TECHNOLOGY DEVELOPMENT LLC, Wilmington, DE (US)

(21) Appl. No.: 12/632,811

(22) Filed: Dec. 8, 2009

(51) Int. Cl. G06F 9/46; G01K 1/00

(52) U.S. Cl. 718/105; 718/102; 702/132

(57) ABSTRACT

Techniques described herein generally relate to multi-core processors including two or more processor cores. Example embodiments may set forth devices, methods, and computer programs related to thermal management in the multi-core processor. Some example methods may include retrieving a first temperature reading for the first processor core during a scheduling interval, retrieving a second temperature reading for the second processor core also during the scheduling interval, and assigning a first task to the first processor core to be executed based on a comparison of the first temperature reading and the second temperature reading retrieved during the scheduling interval.

### BACKGROUND OF THE DISCLOSURE

### Description of the Related Art

Unless otherwise indicated herein, the approaches described in this section are not prior art to the claims in this application and are not admitted to be prior art by inclusion in this section.

A conventional multi-core processor includes two or more independent processor cores arranged in an array. Each processor core generally shares the same voltage control circuit and clock signal control circuit to simplify the interfaces among the processor cores.

The present disclosure recognizes that having such shared control circuits may limit the power management capabilities for the multi-core processor. Moreover, when the processor cores are unequally utilized, one processor core in one region of the die of the multi-core processor may become substantially hotter than another processor core on the same die. The unequal temperatures may cause physical stress on the die.

### BRIEF DESCRIPTION OF THE DRAWINGS

The foregoing and other features of the present disclosure will become more fully apparent from the following description and appended claims, taken in conjunction with the accompanying drawings. These drawings depict only several embodiments in accordance with the disclosure and are, therefore, not to be considered limiting of its scope. The disclosure will be described with additional specificity and detail through use of the accompanying drawings.

FIG. 1 illustrates an example thermal management system for a multi-core processor;

FIG. 2 is a flow chart illustrating a method for processing temperature measurements associated with one or more processor cores in a multi-core processor;

FIG. 3 is a flow chart illustrating a method for assigning one or more tasks to one or more processor cores in a multi-core processor;

FIG. 4 is a flow chart illustrating a method 400 for reassigning one or more tasks to one or more processor cores in a multi-core processor;

FIG. 5 is a schematic diagram illustrating a computer program product for assigning one or more tasks to one or more processor cores in a multi-core processor based on the temperature readings of the one or more processor cores; and

FIG. 6 is a block diagram of an example computing device having a multi-core processor and a processor; all arranged in accordance with at least some embodiments of present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to devices, methods, and computer programs related to thermal management in a multi-core processor as will be described herein. Throughout this disclosure, the term “temperature reading” may broadly refer to a representation of temperature resulting from processing one or more temperature measurements collected by one or more thermal sensors. The temperature measurements may be collected as an analog signal such as a voltage or current, or a digital signal such as a binary code representative of the measurement.

Techniques described herein generally relate to multi-core processors including two or more processor cores. Example embodiments may set forth devices, systems, methods, and/or computer programs related to thermal management in the multi-core processor. Some example methods may include retrieving a first temperature reading for the first processor core during a scheduling interval, retrieving a second temperature reading for the second processor core also during the scheduling interval, and assigning a first task to the first processor core to be executed based on a comparison of the first temperature reading and the second temperature reading retrieved during the scheduling interval.

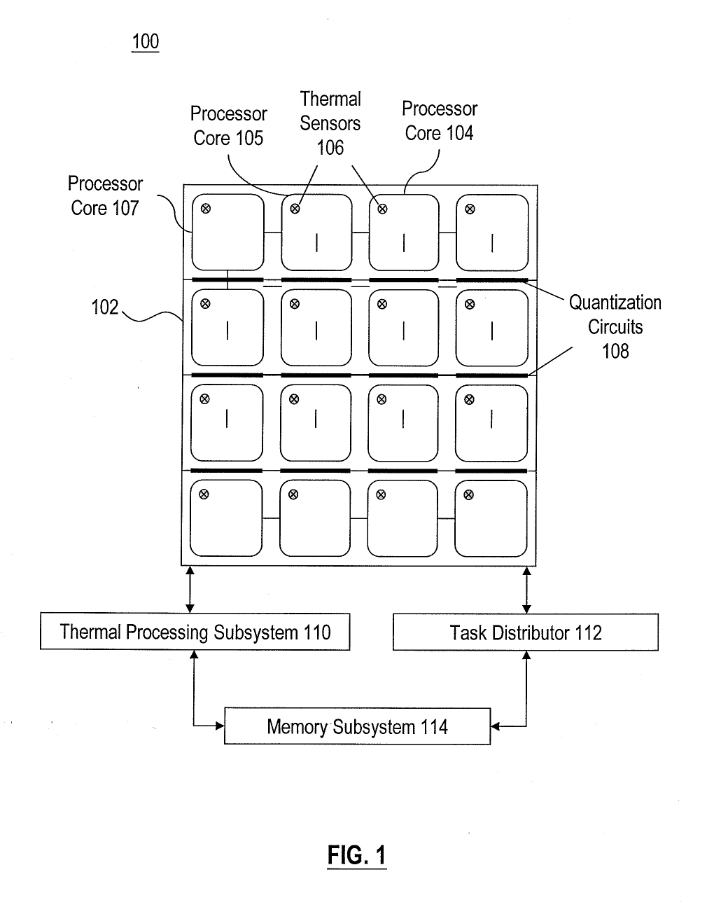

FIG. 1 illustrates an example thermal management system 100 for a multi-core processor 102, arranged in accordance with at least some embodiments of the present disclosure. The multi-core processor 102 may include multiple processor cores, such as a processor core 104, a processor core 105, and a processor core 107, arranged in rows and columns in a 2-dimensional array on an integrated circuit. In some implementations, the processor cores may be adapted to execute programs, processes, threads, or portions thereof. The thermal management system 100 may include one or more thermal sensors 106 coupled to the processor cores, one or more quantization circuits 108, a thermal processing subsystem 110, a task distributor 112, and a memory subsystem 114. The thermal sensors 106 may generally be on the same die as the processor cores.

In some implementations, each thermal sensors 106 (e.g., one or more diodes with pre-determined current/voltage characteristics adapted to operate as thermal sensor devices) may be configured to measure temperatures at various physical locations of a processor core and generate analog output signals corresponding to the measured temperatures. For example, one of the thermal sensors 106 may be coupled to the processor core 105 as shown in FIG. 1 and may be configured to measure the surrounding temperatures at or near the location of the thermal sensor 106 (e.g., the upper left corner of the processor core 105). In other implementations, multiple thermal sensors 106 may be coupled to the same processor core 105 (not shown), so that the surrounding temperatures at or near multiple hot spots associated with the processor core 105 may be measured.

In some implementations, the quantization circuit 108 may be placed in between two processor cores. Examples of the quantization circuit 108 may include an analog-to-digital converter (or ADC), so that the analog temperature measurements (e.g., analog currents or voltage measurements) of the thermal sensors 106 may be converted to discrete digital values. Some example quantization circuits 108 may include one or more buffers, amplifiers, or attenuators to buffer and/or adjust the signal gain of the analog temperature measurements as may be desired. The gain or attenuation may be provided with linear characteristics, non-linear characteristics, or some combination thereof. Some additional example quantization circuits 108 may include active and/or passive filters adapted to prevent instabilities and/or to reduce noise related issues in the analog temperature measurements. Some other examples quantization circuits 108 may include limiters or clamps to prevent the analog temperature measurements exceeding a particular level that may be undesirable. Some examples quantization circuits 108 may include sample and hold, track and hold, and/or switched capacitor circuits adapted to sample the analog signal levels associated with the analog temperature measurements. Some other example quantization circuits 108 may use analog multiplexers to couple to one or more thermal sensors 106. In some other implementations, a single example quantization circuit 108 may monitor every processor core.

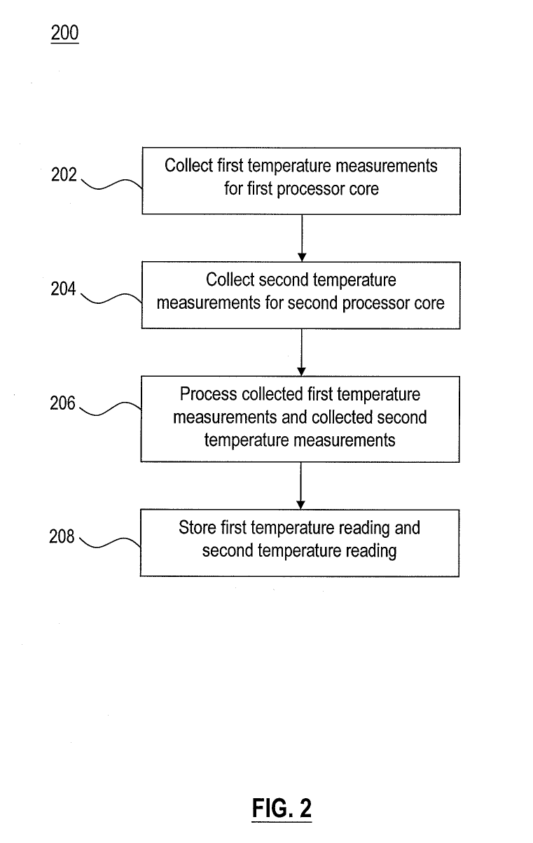

To detect possible thermal imbalances associated with the multi-core processor 102 (e.g., having uneven distribution of heat dissipation in the multi-core processor 102), the thermal processing subsystem 110 may be configured to process the temperature measurements of the thermal sensors 106. In some implementations, the thermal processing system 110 may include a variety of circuits configured to assist in capturing measurements from one or more of the quantization circuits, including but not limited to one or more general or special purpose processor cores, multiplexers, and/or buffers. The thermal processing subsystem 110 may be configured to collect (e.g., via a processor and/or a multiplexer) and aggregate successive temperature measurements (e.g., via a processor) for a particular processing core over a period of time and utilize a function such as, without limitation, minimum, maximum, median, or average, to calculate a temperature reading for the processing core. For the same processing core, the thermal processing subsystem 110 may collect temperature measurements from one or more thermal sensors 106. After having calculated the temperature reading based on the collected temperature measurements, the thermal processing subsystem 110 may be configured to store the calculated temperature reading for the processor core in the memory subsystem 114. Subsequent discussions found herein, such as for FIG. 2, will further detail some operations of the thermal processing subsystem 110.

In some implementations, the task distributor 112 may be configured to assign one or more tasks to one or more processor cores of the multi-core processor 102 based on the temperature readings retrieved from the memory subsystem 114. The task distributor 112 may be a service provided by an operating system that executes on one or more general or special processor cores. During a scheduling interval or time slice, the task distributor 112 may be configured to select a set of tasks from a task buffer (which may reside in the memory subsystem 114) and/or may be configured to assign one or more tasks from the set of tasks to be executed by one or more processor cores of the multi-core processor 102 based on a set of parameters such as, without limitation, the level of workload associated with the tasks and the temperature readings of the processor cores. Subsequent discussions found herein, with their related drawings, will further detail some operations of the task distributor 112.

The memory subsystem 114 may be configured to be accessible by both the thermal processing subsystem 110 and the task distributor 112. In some implementations, the memory subsystem 114 may include different levels of caches to store, for example, without limitation, the processed results of the thermal processing subsystem 110 and/or the aforementioned task buffer. The task distributor 112 may be arranged to retrieve and utilize such processed results in assigning one or more such tasks from the task buffer to one or more processor cores in the multi-core processor 102.

FIG. 2 is a flow chart illustrating a method 200 for processing temperature measurements associated with one or more processor cores in a multi-core processor, arranged in accordance with at least some embodiments of the present disclosure. Method 200 may include one or more operations, functions or actions as illustrated by one or more of blocks 202, 204, 206, and/or 208. Although the blocks are illustrated in a sequential order, these blocks may also be performed in parallel, and/or in a different order than those described herein. Also, the various blocks may be combined into fewer blocks, divided into additional blocks, and/or eliminated based upon the desired implementation.

Processing for the method 200 may begin at block 202, “Collect first temperature measurements for first processor core.” Block 202 may be followed by block 204, “Collect second temperature measurements for second processor core.” Block 204 may be followed by block 206, “Process collected first temperature measurements and collected second temperature measurements.” Block 206 may be followed by block 208, “Store first temperature reading and second temperature reading.”

In block 202, one or more temperature measurements for a first processor core in a multi-core processor may be collected from one or more thermal sensors coupled to the first processor core. Using FIG. 1 as an example, the temperature measurements of the thermal sensor 106 for a first processor core (e.g., the processor core 105) may be collected, by the thermal processing subsystem 110, one or more times during a scheduling interval. If multiple thermal sensors 106 are coupled to the processor core 105, then the temperature measurements of the multiple thermal sensors 106 may be collected for the processor core 105.

In block 204, one or more temperature measurements for a second processor core in the same multi-core processor may also be collected from one or more thermal sensors coupled to the second processor core. In some implementations, the temperature measurements for the first processor core and the second processor core may be collected during the same scheduling interval. In some other implementations, the temperature measurements for the first processor core and the second processor core may be collected from the thermal sensors during different scheduling intervals.

In block 206, the collected first temperature measurements and the collected second temperature measurements may be processed by a thermal processing subsystem. In some implementations, the processing of block 206 may be initiated also by the thermal processing subsystem after a certain number of the first temperature measurements and/or the second temperature measurements have been collected. In conjunction with FIG. 1, a function may be applied, by the thermal processing subsystem 110, to the collected first temperature measurements and the collected second temperature measurements to establish the first temperature reading for the first processor core and the second temperature reading for the second processor core, respectively. Some example functions may include, without limitation, establishing a minimum, a maximum, a median, and an average value based on the collected temperature measurements.

In block 208, the first temperature reading for the first processor core and the second temperature reading for the second processor core may be stored by the thermal processing subsystem for further processing.

In some implementations, the method 200 may be performed repeatedly to collect multiple temperature measurements at different times, process the collected temperature measurements, and store the resulting temperature readings. In other words, one or more first temperature readings for the first processor core and one or more second temperature readings for the second processor core may be stored. Each temperature reading may correspond to a set of temperature measurements that are collected at a certain time or over a certain time interval. In the following discussions, a first temperature reading associated with time 1 may correspond to the first temperature measurements collected at time 1 and may be denoted as a first-temperature-reading_time 1. Similarly, a second temperature reading associated with also time 1 may correspond to the second temperature measurements collected at time 1 and may be denoted as a second-temperature-reading_time 1. Moreover, the method 200 may also be performed in either an analog domain or a digital domain. Thus, the first temperature measurements and the second temperature measurements collected in blocks 202 and 204, respectively, may correspond to sets of discrete analog values or discrete digital values, depending on the specific implementation. One or more quantization circuits, such as the quantization circuits 108 described with reference to FIG. 1, may be utilized to generate such measurement values.

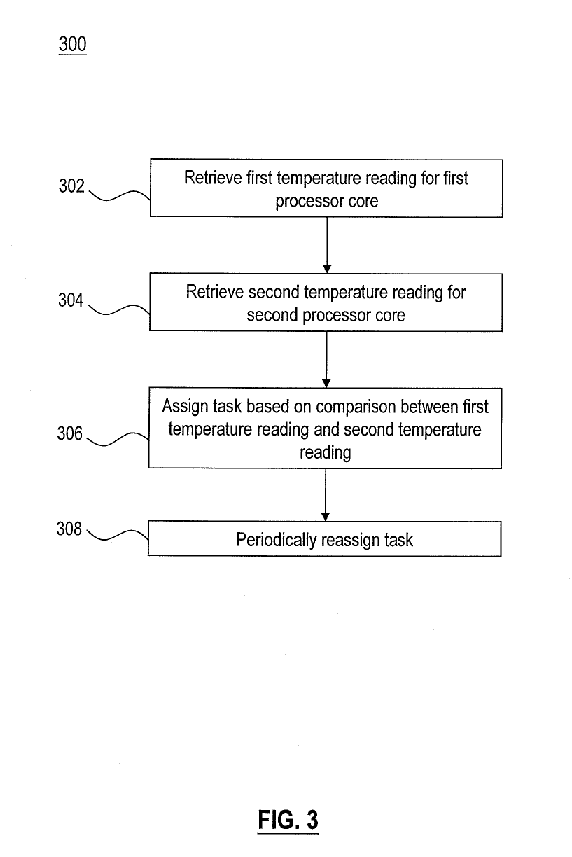

FIG. 3 is a flow chart illustrating a method 300 for assigning one or more tasks to one or more processor cores in a multi-core processor, arranged in accordance with at least some embodiments of the present disclosure. Method 300 may include one or more operations, functions or actions as illustrated by one or more of blocks 302, 304, 306, and/or 308. Although the blocks are illustrated in a sequential order, these blocks may also be performed in parallel, and/or in a different order than those described herein. Also, the various blocks may be combined into fewer blocks, divided into additional blocks, and/or eliminated based upon the desired implementation.

Processing for the method 300 may begin at block 302, “Retrieve first temperature reading for first processor core.” Block 302 may be followed by block 304, “Retrieve second temperature reading for second processor core.” Block 204 may be followed by block 306, “Assign task based on comparison between first temperature reading and second temperature reading.” Block 306 may be followed by block 308, “Periodically reassign task.”

In block 302, the first temperature reading for the first processor core, which results from the processing of the first temperature measurements for the same first processor core, may be retrieved by a task distributor, which may be executed by one or more general or special purpose processor core, from a memory subsystem, such as the memory subsystem 114 as shown in FIG. 1. The retrieval of the first temperature reading may take place during a first portion of a scheduling interval that differs from the scheduling interval in which the first temperature reading is established and stored. In another implementation, the retrieval of the first temperature reading and the storing of the first temperature reading may occur in the same scheduling interval.

In block 304, the second temperature reading for the second processor core, which results from the processing of the second temperature measurements for the same second processor core, may also be retrieved by the task distributor from the same memory subsystem during a second portion of the scheduling interval. In some implementations, the first portion of the scheduling interval associated with the first temperature readings for the first processor core and the second portion of the scheduling interval associated with the second temperature readings for the second processor core may be substantially the same portion of the scheduling interval. In alternative implementations, the first portion and the second portion may be overlapping portions of the scheduling interval. In still other alternative implementations, the first portion and the second portion may be different portions of the scheduling interval. In addition, the first temperature reading and the second temperature reading may be respectively based on the first temperature measurements and the second temperature measurements that are collected at the same or approximately the same time, time 1.

In block 306, based on a comparison performed by the task distributor between the first temperature reading and the second temperature reading, one or more tasks may be assigned to one or more processor cores. In some implementations, the comparison may be to identify the processor core with the lowest temperature reading, so that the one or more tasks may be assigned to such a processor core, which may have the least amount of workload to handle. The task assignment may be performed by the task distributor during the same scheduling interval as the retrieval of the first temperature reading and the second temperature reading.

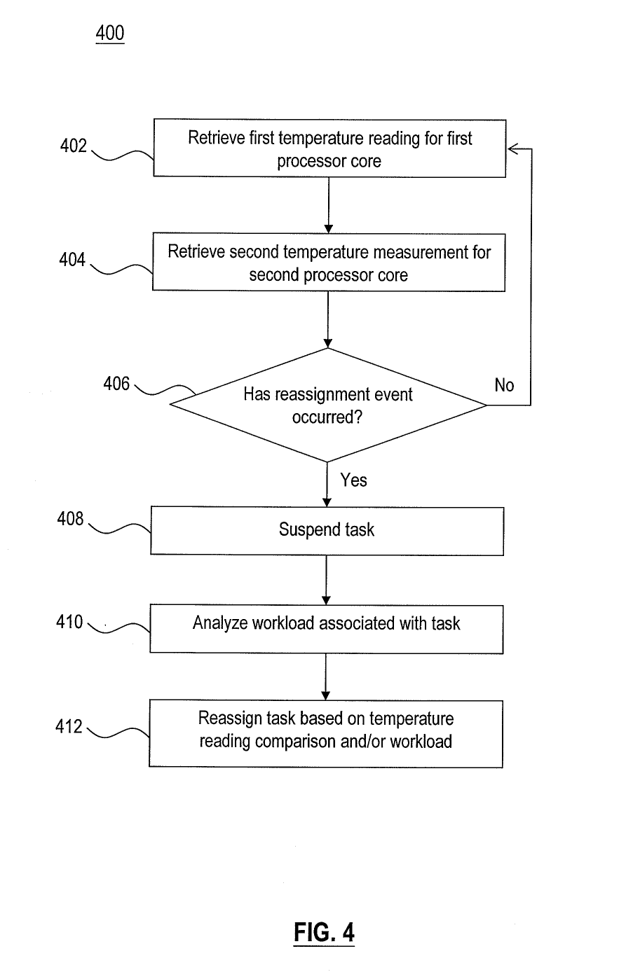

In block 308, the one or more tasks may be reassigned by the task distributor periodically to one or more processor cores. During reassignment, tasks initially assigned to the first processor core may be reassigned to the second processor core and vice-versa. Subsequent discussions associated with FIG. 4 will further detail some operations of task reassignment.

FIG. 4 is a flow chart illustrating a method 400 for reassigning one or more tasks to one or more processor cores in a multi-core processor, arranged in accordance with at least some embodiments of the present disclosure. Method 400 may include one or more operations, functions or actions as illustrated by one or more of blocks 402, 404, 406, 408, 410, and/or 412. Although the blocks are illustrated in a sequential order, these blocks may also be performed in parallel, and/or in a different order than those described herein. Also, the various blocks may be combined into fewer blocks, divided into additional blocks, and/or eliminated based upon the desired implementation.

Processing for the method 400 may begin at block 402, “Retrieve first temperature reading for first processor core.” Block 402 may be followed by block 404, “Retrieve second temperature measurement for second processor core.” Block 404 may be followed by block 406, “Has reassignment event occurred.” When a reassignment event has been determined to occur, then block 406 may be followed by block 408, “Suspend task,” which may be followed by block 410, “Analyze workload associated with task.” Block 410 may be followed by block 412, “Reassign task based on temperature reading comparison and/or workload.” If on the other hand, no reassignment event has been determined to occur in block 406, then processing may continue at block 402, where another set of temperature readings may be retrieved.

In block 402, the first temperature reading for the first processor core may be retrieved by a task distributor, which may be executed by one or more general or special purpose processor cores, from a memory subsystem, such as the memory subsystem 114 as shown in FIG. 1. In some implementations, the retrieved first temperature reading may be for the first temperature measurements collected at time 2, which may be subsequent to the collection time of time 1 as described in the aforementioned method 300.

In block 404, the second temperature reading for the second processor core may also be retrieved by the task distributor from the same memory subsystem. In some implementations, the second temperature reading may be based on the second temperature measurements that may also be collected at the same or approximately the same time 2. In addition, the retrieval operations of block 402 and 404 may occur during substantially the same portions, overlapping portions, or different portions of the same scheduling interval.

In block 406, based on the first temperature reading and the second temperature reading, method 400 may be configured to determine by the task distributor whether a reassignment event has occurred. In some implementations, a reassignment event may be deemed to have occurred, when a temperature differential between the first temperature reading and the second temperature reading exceeds a predetermined threshold value. It is worth noting the temperature differential may be between the temperature readings of two adjacent processor cores (e.g., the processor core 104 and the processor core 105 as shown in FIG. 1) or between the temperature readings of two non-adjacent processor cores (e.g., the processor core 104 and the processor core 107 as shown in FIG. 1). In alternative implementations, a reassignment event may be deemed to have occurred, when the relationship between the first temperature reading and the second temperature reading may have changed. For example, suppose the first temperature reading is initially lower than the second temperature reading. When this relationship between the temperature readings changes, e.g., the first temperature reading becomes higher than the second temperature reading, the reassignment event may be deemed to have occurred. When a reassignment event may be deemed by the task distributor to have occurred in block 406, method 400 may proceed to block 408. Otherwise, method 400 may go back to block 402 and block 404 to retrieve another first temperature reading and another second temperature reading, respectively.

In block 408, prior to reassigning a task by the task distributor to a different processor core, the task may be suspended. To allow a suspended task in one processor core (e.g., the first processor core) to be restarted on another processor core (e.g., the second processor core), the two processor cores may use a shared virtual memory space supported by known memory coherency protocols, such as, without limitation, the MESI protocol.

In block 410, the workload associated with the task to be evaluated for reassignment may be analyzed by the task distributor. In some implementations, one or more performance counters, which may be a set of special-purpose registers, may be utilized to measure and gather performance-related activities of the multi-core processor. For example, the one or more performance counters may be configured to track the number of floating point operations within a given time interval. The performance counters may track the average number of operations waiting for completion in a reorder buffer. The performance counters may track the average memory access time. The performance counters may also track the percentage of instruction issue slots that are utilized.

In block 412, a task initially assigned to one processor core (e.g., the first processor core) may be reassigned by the task distributor to another processor core (e.g., the second processor core). To illustrate, suppose a first task is determined to be associated with higher level of workload than a second task, and the first task is initially assigned to the first processor core. Suppose also that the first temperature reading for the first processor core has become higher than the second temperature reading for the second processor core. In some implementations, the first task may be reassigned to the second processor core having the lower temperature reading, so that the second processor core may be adapted to process a computationally intensive first task.

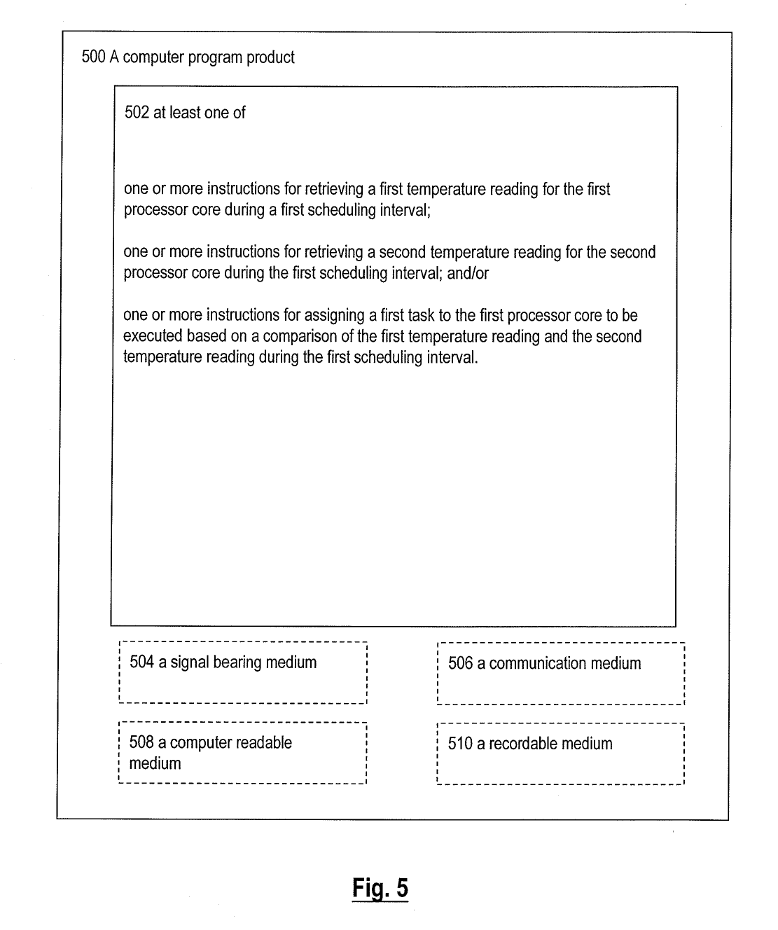

FIG. 5 is a schematic diagram illustrating a computer program product 500 for assigning one or more tasks to one or more processor cores in a multi-core processor based on the temperature readings of the one or more processor cores, arranged in accordance with at least some embodiments of present disclosure. The computer program product 500 may include one or more sets of executable instructions 502 for executing the methods described herein, such as described previously and illustrated in FIG. 2, FIG. 3, and FIG. 4. The computer program product 500 may be transmitted in a signal bearing medium 504 or another similar communication medium 506. The computer program product 500 may also be recorded in a computer readable medium 508 or another similar recordable medium 510.

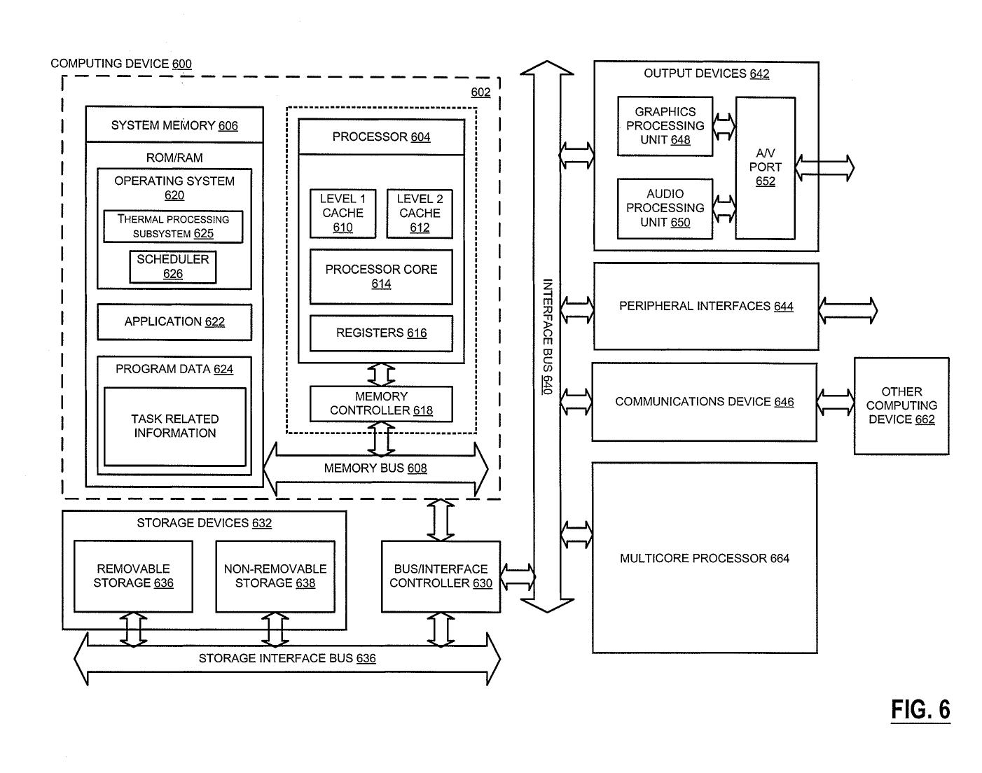

FIG. 6 is a block diagram of an example computing device having a multi-core processor and a processor, arranged in accordance with at least some embodiments of the present disclosure. In a very basic configuration, computing device 600 typically includes one or more processors 604 and a system memory 606. A memory bus 608 may be used for communicating between processor 604 and system memory 606. In some implementations, processor 604 here may refer to a general purpose processor.

Depending on the desired configuration, processor 604 may be of any type including but not limited to a microprocessor (μP), a microcontroller (μC), a digital signal processor (DSP), or any combination thereof. Processor 604 may include one more levels of caching, such as a level one cache 610 and a level two cache 612, a processor core 614, and registers 616. Registers 616 may be utilized to implement the aforementioned performance counters to track the levels of workload associated with various tasks to be assigned. An example processor core 614 may include an arithmetic logic unit (ALU), a floating point unit (FPU), a digital signal processing core (DSP Core), or any combination thereof. An example memory controller 618 may also be used with processor 604, or in some implementations memory controller 618 may be an internal part of processor 604.

Depending on the desired configuration, system memory 606 may be of any type including but not limited to volatile memory (such as RAM), non-volatile memory (such as ROM, flash memory, etc.) or any combination thereof. System memory 606 may include an operating system 620, one or more applications 622, and program data 624. In some implementations, the operating system 620 may include a thermal processing subsystem 625, such as the thermal processing subsystem 110 shown in FIG. 1, and a scheduler 626, which may include a task distributor, such as the task distributor 112 shown in FIG. 1. The thermal processing subsystem 625 may be arranged to perform the functions as described herein including those described with respect to at least method 200 of FIG. 2. The scheduler 626 may be arranged to perform the functions as described herein including those described with respect to at least method 300 of FIG. 3 and method 400 of FIG. 4. Alternatively, application 622 may include the thermal processing subsystem 625 and the scheduler 626 (not shown in FIG. 6), and application 622 may be arranged to operate with program data 624 on operating system 620. Program data 624 may include task related information, such as, without limitation, a task buffer including a set of task for the scheduler 626 to assign to the one or more processor cores in the multi-core processor 664, the temperature readings as discussed in the method 200 of FIG. 2, method 300 of FIG. 3, and method 400 of FIG. 4 that the scheduler 626 may rely upon for the task assignments, and others. This described basic configuration 602 is illustrated in FIG. 6 by those components within the inner dashed line.

Computing device 600 may have additional features or functionality, and additional interfaces to facilitate communications between basic configuration 602 and any required devices and interfaces. For example, a bus/interface controller 630 may be used to facilitate communications between basic configuration 602 and one or more data storage devices 632 via a storage interface bus 634. Data storage devices 632 may be removable storage devices 636, non-removable storage devices 638, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 606, removable storage devices 636 and non-removable storage devices 638 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of computing device 600.

Computing device 600 may also include an interface bus 640 for facilitating communication from various interface devices (e.g., output devices 642, peripheral interfaces 644, and communication devices 646) to basic configuration 602 via bus/interface controller 630. Example output devices 642 include a graphics processing unit 648 and an audio processing unit 650, which may be configured to communicate to various external devices such as a display or speakers via one or more NV ports 652. Example peripheral interfaces 644 include a serial interface controller or a parallel interface controller, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 646 includes a network controller, which may be arranged to facilitate communications with one or more other computing devices 662 over a network communication link via one or more communication ports. In some implementations, computing device 600 includes a multi-core processor 664, which may communicate with the processor 604 through the interface bus 640.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 600 may also be implemented as a personal computer including both laptop computer and non-laptop computer configurations.

There is little distinction left between hardware and software implementations of aspects of systems. The use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes, systems, or other technologies are deployed. For example, if an implementer determines that speed and accuracy are paramount, the implementer may opt for a mainly hardware or firmware vehicle. If flexibility is paramount, the implementer may opt for a mainly software implementation. Yet again, alternatively, the implementer may opt for some combination of hardware, software, with or without firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

Herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

I claim:

1. A thermal management method for a multi-core processor having a first processor core and a second processor core, the method comprising:
retrieving a first temperature reading for the first processor core during a first portion of a scheduling interval;
retrieving a second temperature reading for the second processor core during a second portion of the scheduling interval; and
assigning a first task to the first processor core to be executed based on a comparison of the first temperature reading and the second temperature reading retrieved during the scheduling interval.

2. The method of claim 1, wherein the first portion of the scheduling interval and the second portion of the scheduling interval are either substantially the same portion of the scheduling interval, overlapping portions of the scheduling interval, or different portions of the scheduling interval.

3. The method of claim 1, wherein the first temperature reading is lower than the second temperature reading.

4. The method of claim 3, further comprising:
suspending the first task and reassign the first tasks to the second processor core for execution when the first temperature is determined to be higher than the second temperature reading.

5. The method of claim 1, further comprising:
determining a level of a first workload associated with the first task; and
assigning the first task further based on the determined level of the first workload.

6. The method of claim 1, further comprising:
suspending the first task and reassign the first task to the second processor core for execution when a first temperature differential between the first temperature reading and the second temperature reading is determined to exceed a threshold.

7. The method of claim 1, wherein the first temperature reading is based on a set of first temperature measurements collected at a first time, and the second temperature reading is based on a set of temperature measurements collected at or approximately at the first time.

8. The method of claim 1, wherein the first temperature reading for the first processor core, the second temperature reading for the second processor core, and the first task are retrieved and/or assigned by a processor.

9. A computer readable medium containing instructions for managing thermal environment in a multi-core processor, which when executed by a processor, causes the processor to:
retrieve a first temperature reading during a first portion of a scheduling interval;
retrieve a second temperature reading during a second portion of the scheduling interval; and
assign a first task to the first processor core to be executed based on a comparison of the first temperature reading and the second temperature reading retrieved during the scheduling interval.

10. The computer readable medium of claim 9, wherein the processor is adapted such that the first portion of the scheduling interval and the second portion of the scheduling interval are either substantially the same portion of the scheduling interval, overlapping portions of the scheduling interval, or different portions of the scheduling interval.

11. The computer readable medium of claim 9, further containing additional instructions, which when executed by the processor, causes the processor to:
determine whether a reassignment event has occurred based on the first temperature reading and the second temperature reading;
suspend the first task and reassign the first task to the second processor core for execution when the reassignment event has been determined to occurred.

12. The computer readable medium of claim 11, further containing additional instructions, which when executed by the processor, causes the processor to determine that the reassignment event has occurred when a relationship between the first temperature reading and the second temperature reading changes.

13. The computer readable medium of claim 11, further containing additional instructions, which when executed by the processor, causes the processor to determine that the reassignment event has occurred when a temperature differential between the first temperature reading and the second temperature reading exceeds a predetermined threshold.

14. The computer readable medium of claim 9, further containing additional instructions, which when executed by the processor, causes the processor to:
determine a level of a first workload associated with the first task; and
assign the first task to one of the processor cores further based on the determined level of the first workload.

15. A thermal management system for a multi-core processor having a first processor core and a second processor core, the thermal management system comprising:
a first thermal sensor configured to output a set of first temperature measurements;
a second thermal sensor configured to output a set of second temperature measurements;
a memory subsystem that is configured to store the set of first temperature measurements and the set of second temperature measurements; and
a processor configured to:
retrieve a first temperature reading for the first processor core from the memory subsystem during a first portion of a scheduling interval;
retrieve a second temperature reading for the second processor core from the memory subsystem during a second portion of the scheduling interval; and
assign a first task retrieved from the memory subsystem to the first processor core to be executed based on a comparison of the first temperature reading and the second temperature reading retrieved during the scheduling interval.

16. The system of claim 15, wherein the first portion of the scheduling interval and the second portion of the scheduling interval are either substantially the same portion of the scheduling interval, overlapping portions of the scheduling interval, or different portions of the scheduling interval.

17. The system of claim 15, wherein the processor is further configured to apply a function to the set of first temperature measurements and the set of second temperature measurements to establish the first temperature reading and the second temperature reading, respectively.

18. The system of claim 17, wherein the function is to establish a minimum, a maximum, a median, or an average value based on the set of first temperature measurements and the set of second temperature measurements.

19. The system of claim 15, wherein the processor is further configured to:
determine whether a reassignment event has occurred based on the first temperature reading and the second temperature reading;
suspend the first task and reassign the first tasks to the second processor core for execution when the reassignment event is determined to have occurred.

20. The system of claim 19, wherein the processor is further configured to determine that the reassignment event has occurred when a relationship between the first temperature reading and the second temperature reading changes.

21. The system of claim 19, wherein the processor is further configured to determine that the reassignment event has occurred when a temperature differential between the first temperature reading and the second temperature reading exceeds a predetermined threshold.

22. The system of claim 15, wherein the processor is further configured to:
determine a level of a first workload associated with the first task; and
assign the first task to one of the processor cores further based on the determined level of the first workload.
